(19) United States
(12) Patent Application Publication
(10) Pub. No.: US 2026/0132988 A1
(43) Pub. Date: May 14, 2026

(54) REFRACTORY GAS PURGING PLUG AND METHOD FOR CONTROLLING THE CONDUCTION OF GAS TO A REFRACTORY GAS PURGING PLUG

(71) Applicant: REFRACTORY INTELLECTUAL PROPERTY GMBH & CO. KG, Wien (AT)

(72) Inventors: Wolfgang FELLNER, Leoben (AT); Roland LORENZ, Hünenberg (CH)

(21) Appl. No.: 19/121,163

(22) PCT Filed: Oct. 25, 2023
(86) PCT No.: PCT/EP2023/079774

§ 371 Date: Apr. 15, 2025

(30) Foreign Application Priority Data
Oct. 27, 2022 (EP) 22204212.9

(51) Int. Cl. F27D 3/16; B22D 1/00; F27D 19/00

(52) U.S. Cl. CPC F27D 3/16; B22D 1/005; F27D 19/00; F27D 2003/161

(57) ABSTRACT

The invention relates to a refractory gas purging plug and a method for controlling the conduction of gas to a refractory gas purging plug.

The invention relates to a refractory gas purging plug and a method for controlling the conduction of gas to a refractory gas purging plug.

Gas purging plugs are used for metallurgical treatment of molten metals. They are arranged in the bottom region of a metallurgical vessel, for example in a ladle for secondary metallurgical treatment of a molten steel. Refractory gas purging plugs comprise a body of refractory ceramic material through which gas can be passed. The body extends from a first end of the body to an opposite second end of the body. Gas may be introduced into the body at the first end. The gas introduced into the body flows through the body and exits the body at the opposite, second end of the body. When the gas purging plug is arranged in the bottom region of the metallurgical vessel, the first end is regularly arranged at the bottom and the second end at the top. The second end is in direct contact with a molten metal in the metallurgical vessel.

Gas can therefore be introduced into the molten metal through the gas purging plug, whereby a flow circulating the molten metal is created in the molten metal. This flow can remove harmful gases from the molten metal, transport oxide inclusions into the slag, and homogenize the composition and temperature in the molten metal.

Various technologies are known to allow gas to pass through the body of refractory ceramic material in such a gas purging plug. According to one technology, the body comprises a porous, permeable refractory ceramic material through which gas can be passed. Since this natural gas permeability results from the random, chaotic arrangement of the pore structure in the refractory ceramic material, it is also referred to as “undirected” porosity.

According to another technology, it is known to arrange gas channels of a defined geometry in the body of refractory ceramic material. These gas channels are usually created by first arranging a combustible material in the refractory ceramic material and then burning out and thus removing the combustible material. The burned-out hollow area subsequently forms gas channels. For example, ribbons or filaments of combustible material, such as plastic or cellulose, may be arranged in the ceramic material and subsequently burned out. These gas channels, which have a defined geometry, are also referred to as “directional” porosity.

A refractory ceramic gas purging plug having both such undirected porosity and such directed porosity, namely in the form of slit-shaped gas channels, is disclosed, for example, in EP 1 101 825 A1.

The porous, permeable refractory ceramic material, i.e., the undirected porosity, on the one hand, and the gas channels, i.e., the directed porosity, on the other hand, complement each other. Thus, it may be desired that, depending on the flow rate of the gas flowing through the gas purge plug, a higher proportion of the gas flows through only one of the two porosities in each case.

In this respect, for example, a high flow rate of gas through the gas purging plug is desired for homogenization of the molten metal, which can best be achieved through the gas channels. Harmful gases as well as oxidic inclusions in the molten metal, on the other hand, are best removed by many small gas bubbles, and such gas bubbles are best achieved at low flow rates of gas passing through the porous, permeable refractory ceramic material. In this respect, it is generally desirable that at low flow rates gas preferentially passes through the porous, permeable refractory ceramic material and at higher flow rates gas preferentially passes through the gas channels. Furthermore, a conduction of gas through the gas channels at higher flow rates may be desired in particular also because the porous, permeable refractory ceramic material could be damaged by higher flow rates, in particular also a high mass flow rate of the gas. To this extent, at higher flow rates, it is preferably desired to direct the gas through the gas channels. This conduction of gas through the gas channels can also result in porous, permeable refractory ceramic material being freed again from infiltrated molten metal.

In order to be able to conduct the gas supplied to the refractory gas purging plug both to the porous refractory material and to the gas channels, prior art gas purging plugs regularly have a gas distribution chamber or a porous insert to which the gas is first conducted. From the gas distribution chamber or the porous insert, the gas supplied to the gas purging plug subsequently flows into the porous, permeable refractory ceramic material or into the gas channels.

According to the invention, it has been found that gas cannot always be optimally conducted through a gas purging plug with the aid of such a gas distribution chamber or a porous insert alone. In particular, it is not always possible with prior art gas purging plugs to achieve a conduction of gas through the gas purging plug that is adapted to the flow behavior of the gas.

It is an object of the invention to provide a refractory gas purging plug by means of which gas can be conducted through a gas purging plug in an improved way compared with the gas purging plugs known from the prior art. In particular, it is an object of the invention to provide a refractory gas purging plug by means of which gas can be conducted through the gas purging plug in a manner adapted to the flow behavior of the gas.

In order to solve these tasks, according to the present invention, there is provided a refractory gas purging plug, comprising the following features:
a body of refractory ceramic material;
the body extends from a first end of the body, where gas can be introduced into the body, to a second end of the body, where gas can be discharged from the body, opposite the first end of the body;
the body comprises a first part made of porous, permeable refractory ceramic material which extends from the first end of the body to the second end of the body;
the body comprises a second part made of refractory ceramic material which extends from the first end of the body to the second end of the body, the second part comprising gas channels extending through the second part from the first end of the body to the second end of the body;
gas supply means by which gas can be conducted to the first part and to the second part; wherein
the gas supply means comprise control means by which the conduction of the gas to the first part and to the second part by the gas supply means is controllable.

The invention is based on the finding that gas can be conducted better through a refractory gas purging plug if the gas purging plug comprises gas supply means through which gas can be conducted to the porous, permeable refractory ceramic material and to the gas channels, and if these gas supply means comprise control means by which the conduction of gas via the gas supply means can be controlled. This is because by means of such control means it is also possible, in particular, to achieve a conduction of gas through the gas purging plug which is adapted to the flow behavior of the gas. In particular, these control means allow a targeted conduction of gas to the porous, permeable refractory ceramic material or to the gas channels according to the flow behavior of the gas. For example, these control means allow gas to be directed preferentially through the porous, permeable refractory ceramic material at low flow rates, depending on the flow behavior of the gas, on the one hand, and gas to be conducted preferentially through the gas channels at higher flow rates, on the other hand. In this way, depending on the flow behavior of the gas, an optimum conduction of gas through the gas purge plug is possible in each case.

The controllability of the conduction of gas to the first part (i.e., to the porous, permeable refractory ceramic material) or to the second part (i.e., to the gas channels) also has the particular advantage that the quantity of gas which is conducted to the first part or to the second part can be defined or adjusted. In particular, this has the advantage that the amount of gas that can be directed to the first part or to the second part is controllably adjustable for a desired purging result of the gas purging plug.

The control means may be, for example, a valve by which the conduction of gas to the first part and/or to the second part is controllable. Preferably, the control means may be designed in the manner of a directional control valve. By designing the control means in the manner of such a directional control valve, the conduction of gas to the first part and to the second part can be controlled very simply and effectively. Advantageously, such a directional control valve can also be provided in a very robust and simple manner.

According to a preferred embodiment, the conduction of the gas to the first part and to the second part by the gas supply means is controllable by the control means dependent on the flow behavior of the gas.

The advantage of such controllability of the conduction of gas depending on the flow behavior of the gas is in particular that no additional or external control of the gas conduction is necessary. Rather, the conduction of gas line can be self-regulating depending on the flow behavior of the gas. The particular advantage of this is that the proportion of gas that is conducted to the first part or to the second part in each case can be made dependent on the flow behavior of the gas. In this embodiment, the flow behavior of the gas itself can control which proportion of gas flows to the first part or to the second part. The flow behavior of the gas in this sense can preferably be the flow behavior of the gas in the gas supply means, in particular in the area of the control means.

Such a controllability of the conduction of gas by means of the flow behavior can, for example, again be achieved very simply and effectively by means of a control means designed in the manner of a directional control valve, wherein the directional control valve can be actuated by the gas, i.e., pneumatically, by the valve having an actuator (in particular a piston or a spool) which can be moved into different switching positions of the valve depending on the flow behavior of the gas.

According to a particularly preferred embodiment, this flow behavior of the gas is the mass flow of the gas. In this embodiment, the conduction of the gas to the first part and to the second part through the gas supply means is thus controllable by the control means depending on the mass flow of the gas. As is well known, mass flow is defined is the mass of a medium moving through a cross-section per period of time. The mass flow of the gas in the present case is therefore the mass of the gas that moves through a cross-section per period of time. The cross-section can preferably be a defined cross-section of the gas supply means, in particular in the area of the control means. According to the invention, it has been found that the conduction of gas to the first part and to the second part can be controlled particularly easily and effectively as a function of the mass flow of the gas.

According to a preferred embodiment, it may be provided that by the control means the conduction of gas is controllable such that gas can be conducted via the gas supply means either to the first part or to the second part. The first part (i.e., the porous, permeable refractory ceramic material) and the second part (i.e., the gas ducts) are thus not simultaneously supplied with gas.

According to a particularly preferred embodiment, it may be provided that the conduction of the gas to the first part and to the second part by the gas supply means is controllable by the control means such that the gas can be conducted either to the first part but not to the second part or to the second part but not to the first part.

According to one embodiment, it is provided that the conduction of gas to the first part and to the second part via the gas supply means is controllable by means of the control means in dependence on at least one range or value range, respectively, of the mass flow rate of the gas. For example, this controllability may depend on whether or not the mass flow rate of the gas is within or outside such a range or value range of the mass flow rate of the gas. This value for the mass flow rate of the gas is preferably defined.

According to one embodiment, it is provided that the conduction of the gas to the first part and to the second part by the gas supply means is controllable by the control means dependent on the mass flow rate of the gas in such a way that, in case the mass flow rate lies within a first range, the gas can be conducted to the first part, and in case the mass flow rate lies within a second range, the gas can be conducted to the second part.

According to a further embodiment of this inventive idea, it may be provided that the first range is lower than the second range.

According to a further embodiment of this invention, it may be provided that the conduction of the gas to the first part and to the second part by the gas supply means is controllable by the control means dependent on the mass flow rate of the gas in such a way that, in case the mass flow rate lies within a first range, the gas can be conducted to the first part but not to the second part, and in case the mass flow rate lies within a second range, the gas can be conducted to the second part but not to the first part, wherein the first range preferably is lower than the second range.

By the aforementioned embodiment of the invention, it can be achieved that at lower mass flow rates of the gas, the gas is conducted to the porous permeable refractory ceramics material, while at higher mass flow rates of the gas, the gas is conducted to the gas channels. Hereby, by means of the gas purging plug according to the present invention, a particularly advantageous conduction of gas through the gas purging plug can be achieved.

According to a further development of this inventive idea, it may be provided that the conduction of the gas to the first part and to the second part by the gas supply means is further controllable by the control means dependent on the mass flow rate of the gas in such a way that, in case the mass flow rate lies within a third range, the gas can be conducted to the first part and to the second part, wherein the third range is higher than the first range and lower than the second range.

By this measure, an advantageous conduction of gas simultaneously through the first part and the second part can be achieved, in particular at medium flow rates of the gas.

According to one embodiment, it may be provided that the control means comprise an actuator, in particular a piston or spool. Preferably, the actuator may assume different positions. Preferably, the actuator can assume the different positions depending on the flow behavior of the gas. According to a preferred embodiment, it may be provided that the conduction of gas to the first part and to the second part is controllable in dependence on the positions of the actuator. In this respect, the actuator can be designed in the manner of a control piston or a spool in a directional control valve, wherein the positions of the actuator release or plug a gas path.

Preferably, it can be provided that the actuator can assume at least a first position and a second position. It may further be provided that the actuator may assume a first position when the mass flow of the gas is in the aforementioned first range, and may assume the second position when the mass flow of the gas is in the aforementioned second range. According to a further embodiment, it may further be provided that the gas cannot be directed to the second part in the first position and cannot be directed to the first part in the second position.

According to a further embodiment of the present invention, it may be provided that the actuator assumes a third position when the mass flow rate of the gas lies within the third range, and wherein in the third position, the gas can be conducted to the first part and to the second part.

Accordingly, the actuator assumes this third position when the mass flow rate of the gas lies between the first range (i.e., a lower mass flow rate of the gas) and the second range (i.e., a higher mass flow rate of the gas), and in this position, the actuator can control the conduction of gas to the first part and to the second part such that gas can be conducted to both the first part and the second part.

Generally, the gas supply means can be any device through which gas can be conducted to the first part and to the second part. Preferably, the gas supply means are arranged in the region of the first end of the body of refractory ceramic material of the gas purging plug. Preferably, the gas supply means, as also known from the prior art, are designed in the form of a nozzle or cap, respectively, which is arranged at the first end of the body of refractory ceramic material, i.e., at the gas inlet side of the gas purging plug. Preferably, the gas supply means are formed of metal. Preferably, the control means are arranged in the gas supply means, i.e., for example, in the gas supply means formed as a nozzle or as a cap.

The gas supply means preferably have a gas connection to which a gas line may be connected. The gas line, in turn, may be connected to a gas source. Gas can accordingly be conducted from the gas source via the gas line into the gas supply means, and the gas subsequently being conducted via the gas supply means to the first part and to the second part of the body of refractory ceramic material of the gas purging plug.

As known from the prior art, the gas purging plug may preferably comprise one or more gas distribution chambers via which gas may be introduced into the first part and the second part.

Preferably, the gas distribution chambers are arranged at the first end of the body of refractory ceramic material, as known from the prior art, so that gas from the gas distribution chambers can be introduced directly into the first part and into the gas channels of the second part.

According to a preferred embodiment the refractory gas purging plug further comprises: a first gas distribution chamber disposed at the first end of the body; a second gas distribution chamber disposed at the first end of the body; wherein gas can be introduced into the first part via the first gas distribution chamber; and gas can be introduced into the second part via the second gas distribution chamber.

The advantage of such a first and second gas distribution chamber is in particular that gas can be selectively introduced into the first part via the first gas distribution chamber and thus into the porous, permeable refractory ceramic material and into the second part via the second gas distribution chamber and thus into the gas channels.

According to one embodiment, it may be provided that the first gas distribution chamber and the second gas distribution chamber are separated from each other, for example by a wall. According to a further embodiment of this invention, it may be provided that the first gas distribution chamber and the second gas distribution chamber are fluidically separated from each other. This has the particular advantage that the gas in the first gas distribution chamber and the gas in the second gas distribution chamber do not mix with each other, so that gas can be directed specifically into the first part via the first gas distribution chamber and into the second part via the second gas distribution chamber.

Insofar as the gas purging plug comprises gas distribution chambers, gas can be conducted from the gas supply means first into the gas distribution chambers and via these into the first part and into the second part, more specifically, into the gas channels of the second part.

According to one embodiment, it is provided that gas can be conducted to the first part by the gas supply means via the first gas distribution chamber and wherein gas can be conducted to the second part by the gas supply means via the second gas distribution chamber.

According to one embodiment, it is provided that gas cannot be introduced into the second part via the first gas distribution chamber.

According to one embodiment it is provided that gas cannot be introduced into the first part via the second gas distribution chamber.

The aforementioned embodiments can ensure in a special way that gas can be introduced into the first part via the first gas distribution chamber and gas can be introduced into the second part via the second gas distribution chamber. In this way, a targeted conduction of the gas either to the porous, permeable refractory ceramic material or to the gas channels can be achieved in a particularly advantageous manner according to the flow behavior of the gas.

A “gas distribution chamber” in the sense of the invention is, as known from the prior art, a space enclosed or defined, respectively, by walls. The gas distribution chamber need not be completely enclosed by walls. Rather, the walls enclosing the gas distribution chamber may, for example, have openings, for example to direct gas into the gas distribution chamber.

According to a preferred embodiment, it is provided that the space defined by the first gas distribution chamber is partially defined by the first part. In other words, the first part constitutes a portion of the wall defining the space enclosed by the first gas distribution chamber. Since the first gas distribution chamber is arranged at the first end of the body of refractory ceramic material of the gas purging plug according to the invention, this feature is particularly easy to achieve. In particular, a particular advantage of this feature is that gas can be conducted to the first part particularly easily through the first gas distribution chamber when the first part constitutes a portion of the wall of the first gas distribution chamber.

According to one embodiment, it is provided that the space defined by the second gas distribution chamber is partially defined by the second part. In other words, the second part constitutes a portion of the wall defining the space enclosed by the second gas distribution chamber. Since the second gas distribution chamber is arranged at the first end of the body of refractory ceramic material of the gas purging plug according to the invention, this feature is particularly easy to achieve. A particular advantage of this feature is, in particular, that gas can be conducted to the second part or to the gas channels formed in the second part particularly easily through the second gas distribution chamber if the second part constitutes a portion of the wall of the second gas distribution chamber.

Preferably, the further parts of the wall of the first and second gas distribution chambers that are not defined by the first part and the second part may be formed of metal, such as known from the prior art. It may be provided that parts of the wall of the first and second gas distribution chambers can be part of the gas supply means via which gas can be conducted to the first part and the second part.

In order to conduct gas into the first gas distribution chamber, it can be provided that the first gas distribution chamber has at least one first gas supply opening via which gas can be introduced into the first gas distribution chamber.

In order to conduct gas into the first gas distribution chamber, it can be provided that the second gas distribution chamber has at least one second gas supply opening via which gas can be introduced into the second gas distribution chamber.

Preferably, gas can be introduced into the first gas distribution chamber through the gas supply means via the first opening. Similarly, gas can preferably be introduced into the second gas distribution chamber through the gas supply means via the second gas supply opening.

As stated above and according to the usual nomenclature in the field of refractory gas purging plugs, “gas channels” according to the invention are understood to be channels with a defined geometry, which in the state of the art is in particular also understood to be “directed” porosity. These gas channels are in this respect, as explained above, in contrast to porous, permeable refractory ceramic material, in which the natural gas permeability results from the random, chaotic arrangement of the pore structure in the refractory ceramic material, and which is therefore also referred to as “undirected” porosity.

As set forth above, preferably, the gas channels may have been created by burning out combustible material in order to provide gas channels with a defined geometry.

According to a one embodiment, it may be provided that the gas channels which extend through the second part form at least one net.

According to a one embodiment, it may be provided that the first part provides a surface and wherein the at least one net at least partially extends directly on the surface of the first part.

According to the invention, it has been found that a net formed by the gas channels makes it possible to achieve a particularly advantageous homogenization of the molten metal. The invention is based on the further finding that with the gas purging plug according to invention, it is possible that in particular at high mass flows of the gas channels are freed again from infiltrated molten metal. The invention is based on the further finding that with the gas purging plug according to invention, it is possible that metal infiltrations can be removed very carefully, without damaging the sensitive porous, permeable refractory ceramic material.

The inventors assume that the flow of the gas through the different porosities, which depends on the flow rates, is due to the fact that, first, there is a certain amount of gas exchange between the porous, permeable refractory ceramic material and the gas channels and that, second, at low flow rates gas preferentially passes through the porous, permeable refractory ceramic material and at higher flow rates gas preferentially passes through the gas channels. The inventors assume that this effect might be based on the fact that, at low flow rates, the gas channels are blocked by infiltrated molten whereas, at high flow rates, metal infiltrations in the channels can be blown out or removed, respectively, from the first part very carefully, without damaging the sensitive porous, permeable refractory ceramic material. Thus, at high flow rates, gas flowing through the porous, permeable refractory ceramic material passes to some extent into the gas channels, blowing out metal infiltrations from the gas channels and then flowing through the gas channels. At the same time, as the gas passes at high flow rates from the porous, permeable refractory ceramic material into the gas channels, the sensitive porous, permeable refractory ceramic material is not damaged.

According to the invention, it has also been found that a gas purging plug can be provided very easily in terms of manufacturing technology if the gas channels form at least one such net. This is because for this purpose, as explained in detail further below, a net-shaped combustible material can first be arranged very simply on the first part, for example by simply slipping the combustible net over the first part, which is then surrounded with refractory material.

The gas channels form a “net” in the sense of the invention, insofar as the gas channels have a net-like structure or run net-like.

According to one embodiment, the gas channels form at least one net consisting of groups of gas channels each running parallel to each other and crossing each other. This results in a symmetrical structure of the network which again leads to uniform injection of the gas in the steel melt, thereby reducing inconsistent wear of the plug.

According to one embodiment, the gas channels form at least one symmetrical net.

According to the invention, it was found that such a symmetrical net formed by the gas channels makes it possible to achieve a particularly advantageous homogenization of the molten metal. Furthermore, it was found that through such a symmetrical net gas can diffuse particularly uniformly into the first part, so that the first part can be freed particularly carefully from any metal infiltrations.

Preferably, the gas channels extend linearly, i.e., along a straight line. This allows a particularly uniform, in particular laminar, flow to be generated within the gas channels, whereby gas can be injected particularly uniformly both into the molten metal and diffuse into the first part which again can prevent inconsistent wear of the plug.

According to one embodiment, it is provided that the net comprises meshes surrounded by the gas channels, and wherein the meshes have a mesh size in the range of 1 to 10 mm, more preferably in the range of 2 to 8 mm and even more preferably in the range of 3 to 5 mm. This allows easy production and prevents errors in the channel structure. A “mesh” within the sense of the present invention represents an area surrounded by gas channels.

Preferably, the gas channels at least mainly have a constant cross-sectional area. The cross-sectional area in this sense is the cross-section of the gas channels perpendicular to their longitudinal extension. A constant cross-sectional area prevents wear compared to areas having non constant cross-sections. According to a preferred embodiment, the gas channels have a constant cross-sectional area beyond the nodes of the net of the gas channels. The “nodes” of the net of gas channels are the points of the net where the gas channels cross.

Preferably, the gas channels have a circular cross-sectional area. This is particularly preferable when a plurality of adjacent nets of gas channels are provided as the contact surface of said nets of gas channels is minimized and gas infiltration between said nets of gas channels is limited.

Preferably, the gas channels have a diameter in the range of 0.1 to 2.0 mm, more preferably in the range of 0.1 to 1.0 mm and even more preferably in the range of 0.2 to 0.9 mm. The diameter in this sense is the diameter of the gas channels perpendicular to their longitudinal extension. In case the gas channels do not have a circular cross-sectional area, the diameter is the maximum distance between the channel walls perpendicular to the longitudinal extension of the gas channels.

According to the invention, it has been found that with gas channels having such a diameter, gas can be injected into the molten metal through the gas channels in a particularly advantageous manner, in particular also at a high mass flow of the gas, whereby good homogenization of the molten metal can be achieved, but at the same time infiltration of molten metal into the gas channels can be completely or largely prevented.

According to one embodiment, it is provided that the refractory ceramic material of the second part has a lower permeability than the refractory ceramic material of the first part.

According to one embodiment, it may also be provided that the refractory ceramic material of the second part is impermeable to gas, in particular to gas at the gas pressures prevailing in a refractory gas purging plug. According to one embodiment, it may be provided that the refractory ceramic material of the second part has a permeability of <2 nPerm, preferably <0.05 nPerm.

According to one embodiment, it is provided that the first region has a permeability in the region of 50 to 400 nPerm, preferably 60 to 250 nPerm.

The permeability values given herein are determined according to the standard ISO 8841:1991-09.

According to the invention, it was found that with such a permeability of the first part, in particular at a low mass flow rate of the gas passing through the first part, gas can be passed through the first part such that the gas flowing through the first part into the molten metal generates many small gas bubbles in the molten metal, through which harmful gases and oxidic inclusions can be removed from the molten metal advantageously. Furthermore, it was found that with such a permeability of the first part, gas can diffuse particularly well from the gas channels into the first part and free it from metal infiltrations, as previously explained.

According to a preferred embodiment, it is provided that the second part surrounds the first part.

According to the invention, it has been found that the second part can be particularly advantageously freed from metal infiltration by the gas channels of the first part when the second part surrounds the first part.

Generally, the first part may have any shape. For example, the first part may have a circular cross-section, a polygonal cross-section or a combination of such cross-sections. The polygonal cross-section may be, for example, a rectangular cross-section. For example, the first part may comprise at least one section having a circular cross-section and at least one section having a polygonal cross-section.

As far as the first part has a circular cross-section, the first part may have, for example, a circular cylindrical shape, with the longitudinal axis of the circular cylinder extending from the first end of the body to the second end of the body. Alternatively, it may be provided that the first part, as far as it has a circular cross-section, has a frustoconical shape with its longitudinal axis extending from the first end of the body to the second end of the body and tapering in that direction.

As far as the first part has a polygonal cross-section, the first part may have, for example, have a cuboid, prismatic or wedge shape, with the longitudinal axis of these shapes extending from the first end of the body to the second end of the body. According to one embodiment, it may be provided that the area of the cross-section tapers in the direction from the first end of the body to the second end of the body.

According to one embodiment, it may be provided that the first part is one-piece, in particular, comprised of one piece having uniform properties.

According to a preferred embodiment, the first part comprises a first segment and a second segment, wherein these segments have different properties. Preferably, the first segment and the second portion differ in at least one of the following characteristics: shape or porosity. A significant advantage of the first part having different segments with different properties is, in particular, that each segment can be optimized with respect to certain properties.

According to one embodiment, the first part comprises a first segment disposed immediately adjacent the first end of the body of refractory ceramic material and a second segment disposed immediately adjacent the second end of the body of refractory ceramic material. In other words, the first segment forms a part of the first end of the body and the second segment forms a part of the second end of the body.

To the extent that the first segment and the second segment differ in shape, it is preferred that the first segment has a polygonal cross-section as set forth above, and that the second segment has a circular cross-section as set forth above. A significant advantage of this embodiment is that the first and second segments are visually distinct from one another and the first segment can therefore also act as a wear indicator. A further advantage is that only the second segment adjacent to the second end of the body can be formed with a circular cross-section. In this respect, however, it must be taken into account that it is advantageous for the inlet of the gas from the porous permeable refractory material into the melt if this material has a circular cross-section, but such a circular cross-section is more difficult to realize in terms of manufacturing technology than a polygonal cross-section.

Preferably, it is provided that the first segment may have the function of a wear indicator as known in the prior art. As is known, after removal of the molten metal from the melting vessel, the first segment may be visually recognizable and thereby indicates progressed wear of the gas purging plug.

To the extent that the first segment and the second segment differ in porosity, it is preferably provided that the first segment comprises a porous permeable refractory ceramic material having a first permeability and the second segment comprises a porous permeable refractory ceramic material having a second permeability, wherein the first permeability and the second permeability are different. Particularly preferably, it is provided that the first permeability is greater than the second permeability. According to a preferred embodiment, it is provided that the first permeability is in the range of 50 to 400 nPerm, preferably 60 to 250 nPerm and the second permeability is in the range of 50 to 400 nPerm, preferably 60 to 250 nPerm. Preferably the first and second permeability are identical. The advantage of such an embodiment also lies in particular in the fact that larger quantities of gas can be passed through the first segment than through the second segment. As a result, gas can be conducted from the first segment to the second segment as well as to gas channels directly adjacent thereto, as described further below. By the second segment simultaneously conducting a smaller amount of gas, the self-regulating effect described above results, whereby at low gas flow rates, gas flows through the porous permeable refractory material and at higher flow rates, gas flows through the gas channels.

Preferably, the first segment has a surface that runs at a distance from the first end of the body. Thus, this surface of the first segment runs “inside” the body. Preferably, this surface runs parallel to the first end of the body.

According to a particularly preferred embodiment, it is provided that the first segment has a first contact surface and the second segment has a second contact surface, the first contact surface and the second contact surface abutting against each other. Thus, the first segment and the second segment are directly adjacent to each other. In particular, this also has the advantage that gas flowing through the first segment can flow directly from the first segment into the second segment. Particularly preferably, the first contact surface and the second contact surface extend at a distance from the first end and the second end of the body, that is, “inside” the body. According to one embodiment, the first and second contact surfaces run parallel to the first end of the body.

The gas channels, which form at least one net which at least partially extends directly on the surface of the first part, extend through the second part. In principle, the gas channels may extend through the second part for any distance between the first end of the body and the second end of the body. Preferably, the gas channels extend to the second end of the body. This has the advantage that gas can be released from the body into the molten metal via the gas channels at the second end of the body.

It may be provided that the gas channels extend to the first end of the body. This allows gas to be introduced into the body via the gas channels at the first end of the body. According to a further embodiment of this embodiment, the gas channels simultaneously extend to the second end of the body as set forth above. In this respect, the gas channels extend from the first end of the body to the second end of the body. This allows gas to pass through the body from the first end of the body to the second end of the body via the gas channels.

According to an alternative preferred embodiment, the gas channels are provided to extend through the second part at a distance from the first end of the body. Thus, in this embodiment, the gas channels do not extend to the first end but rather end spaced from the first end of the body.

In case of an embodiment in which the first part is one-piece, and wherein the gas channels are provided to extend through the second part at a distance from the first end of the body the gas channels end spaced from the fist end of the body in region of the first part between the first end and the second end of the body.

In case of an embodiment where the first part comprises a first segment and a second segment, as set forth herein, and wherein the gas channels are provided to extend through the second part at a distance from the first end of the body, gas is preferably supplied to the gas channels via the first part made of porous, permeable refractory ceramic material by introducing gas into the first part and, as explained above, via gas exchange between the first part and the gas channels, gas is conducted from the first part into the gas channels. Insofar as the first segment, as set forth above, has a first contact surface at which the first segment abuts against the second segment, according to a further embodiment, it is provided that the gas channels extend from this contact surface through the second part in the direction towards the second end. In this embodiment, the gas channels are thus arranged with a distance towards the first end corresponding to the distance of the first contact surface towards the first end. Preferably, in this embodiment, the gas channels are in contact with the first contact surface. This allows gas flowing through the first segment to flow directly from the first segment into the gas channels.

According to the invention, it has been found that the second part and, hence, the gas channels, can be particularly advantageously freed from infiltrated metal, in particular when the second part surrounds the first part.

Generally, the first part may be made of any porous, permeable refractory ceramic material. In particular, the first part may be made of any porous, permeable refractory ceramic material known as porous, permeable refractory ceramic material for gas purge plugs. Preferably, the first part is made of a sintered porous permeable refractory ceramic material. Preferably, the first part may be made based on at least one of the following refractory ceramic materials, in particular materials sintered together: magnesia, alumina, spinel, mullite and fireclay.

The second part can be made of any refractory material, in particular a refractory ceramic material with a low permeability. In this respect, refractory materials known from the prior art can be used. Preferably, the refractory ceramic material of the second part is in the form of a refractory cement or a ceramic mass, i.e., an unshaped refractory ceramic product. Preferably, the second part may be made based on at least one of the following refractory ceramic materials: magnesia, alumina, spinel, mullite and fireclay.

In order to provide the gas channels in the second part, use can be made of the technologies known in the prior art for creating gas channels in a refractory gas purge plug. Preferably, the gas channels can be created by first embedding a combustible material in refractory ceramic material, then heating this refractory ceramic material so that the combustible material burns out and subsequently forms the gas channels. Preferably, such combustible material has the shape of one or more nets which, preferably, are arranged on the surface of the first part. For example, the at least one net from combustible material can be pulled over the surface of the first part.

The combustible material may be organic, preferably weavable, material, e.g., cotton, cellulose or plastic, for example one of the following plastics: soft polyethylene, soft polypropylene or polyethersulfone.

According to one embodiment of the invention, it may be provided that the gas channels take the place of a burned-out material.

As known in the prior art, the gas purging plug may comprise a metal shell or sleeve surrounding the body of refractory ceramic material.

The body of refractory ceramic material may be produced by a method, comprising the following steps:
Providing an element of refractory ceramic material; wherein
   the element extends from a first end of the element to a second end of the element opposite the first end of the element; the element comprises a first section made of a first refractory material which extends from the first end of the element to the second end of the element; and the element comprises a second section made of a second refractory material which extends from the first end of the element to the second end of the element, the second section comprising combustible material embedded into the second refractory material and extending through the second section from the first end of the element to the second end of the element; and
heating the element.

Preferably, the combustible material forms at least one net. Further preferably, the at least one net at least partially extends directly on the surface of the first section.

For example, the combustible material can be pulled over first part such that it runs is at least partially directly on the surface of the first section before applying the second section around the combustible material.

After the heating step, the element of refractory ceramic material forms the body of refractory ceramic material of the gas purging plug of the invention.

The combustible material can be embedded into the second refractory material by applying combustible material, which preferably forms at least one net, preferably at least partially directly on the surface of the first section and afterwards applying the second section around the combustible material.

The method for the production of a refractory gas purging plug might further comprise the step of applying stripes of combustible material on the surface of the first section from the first end of the element to the second end of the element before providing the second section.

After heating, the first section of the first refractory material forms the first part of the body made of porous, permeable refractory ceramic material. The first section made of a refractory material preferably is a shaped body. As stated above, the first part is preferably in the form of a sintered body. Accordingly, the first section may be in the form of a sintered body. Alternatively, the first section is a shaped green body, wherein the heating is preferably performed such that the first refractory material is sintered by the heating to form a porous permeable refractory ceramic material. The first refractory material is preferably based on at least one of the following refractory ceramic materials: magnesia, alumina, spinel, mullite and fireclay. Preferably, the first segment is in the form of a shaped product, in particular a pressed product, in particular in the form of a green body.

After heating, the second section of the second refractory material forms the second part of the body of refractory ceramic material of the gas purging plug according to the invention. The second refractory material is preferably based on at least one of the following refractory ceramic materials: magnesia, alumina, spinel, mullite and fireclay. In order to form the gas channels in the second section during heating, combustible material embedded in the second refractory material is present. During heating, the combustible material burns out so that the gas channels take the place of the burned-out material after heating. According to a particularly preferred embodiment, in order to embed the combustible material in the second refractory material, the combustible material is first arranged on the surface of the first section and then embedded in the second material. For embedding, the second refractory material can, for example, subsequently be placed, in particular poured, onto the combustible material arranged onto the first refractory material. For this purpose, the first section with the combustible material arranged thereon may be arranged in a mold or template, for example. Preferably, the second refractory material can be present or applied for this purpose in the form of a refractory cement or in a ceramic mass, i.e., an unshaped refractory ceramic material. Preferably, the first section for this purpose is in the form of a shaped product, as explained above, so that the first section provides a surface on which the combustible material can be arranged particularly easily. As stated above, the combustible material thereby forms gas channels after heating, preferably in the form of at least one net, which preferably at least partially extends directly on the surface of the first part. A particular advantage of the use of at least one such net as combustible material is also that such nets can be arranged particularly easily on the surface of the first part by simply being drawn onto the first part. Generally, the combustible material can be any material which burns out by heating, for example paper, cardboard or any synthetic material, in particular plastic.

Preferably, the combustible material is present as plastic, particular preferable in the form of at least one of the following plastic materials: soft polyethylene, soft polypropylene or polyethersulfone.

Preferably, the heating is carried out at such temperatures at which the combustible material burns out or incinerates, respectively. Preferably, the heating is carried out at temperatures in the range from 200 to 600° C., in particular in the range from 400 to 600° C., thereby preferably curing the second refractory material. Within this range, the aforementioned combustible material can be burned out or incinerated, respectively.

Preferably, the method is carried out such that the second section surrounds the first section.

To produce the gas purging plug according to the invention, after heating or firing, the gas supply means may subsequently be arranged on the obtained body.

Further, the first and second gas distribution chamber may be arranged on the obtained body.

Furthermore, after firing, a shell or sleeve may be arranged on the body such that it surrounds the body of refractory ceramic material, as set forth above.

Generally, the refractory gas purging plug according to the invention may be used to be arranged in the bottom region of a metallurgical vessel. In particular, it may be provided to use the refractory gas purging plug according to the invention in the bottom region of a vessel for receiving a molten metal, in particular molten steel. Particularly preferably, it is provided to use the gas purging plug according to the invention to be arranged in the bottom region of a steel ladle, in particular in a continuous casting plant for treating molten steel.
A further subject of the present invention is to provide a metallurgical vessel with a gas purging plug according to the invention arranged in the bottom region of the metallurgical vessel. The metallurgical vessel may in particular be a metallurgical vessel as described above.

It is a further subject of the present invention to provide a method for controlling the conduction of gas to a refractory gas purging plug, the method comprising the following steps:
providing a refractory gas purging plug according to the present invention;
controlling the conduction of gas to the first part and to the second part by the gas supply means.

The controlling of the conduction of gas to the first part and to the second part by the gas supply means may thereby be carried out as set forth herein.

Further features of the invention will be apparent from the claims, the figures and the accompanying description of the figures.

All features of the invention may, individually or in combination, be combined with each other.

An exemplary embodiment of the invention is shown schematically in the figures and explained in more detail by the description.

In the figures there is shown in

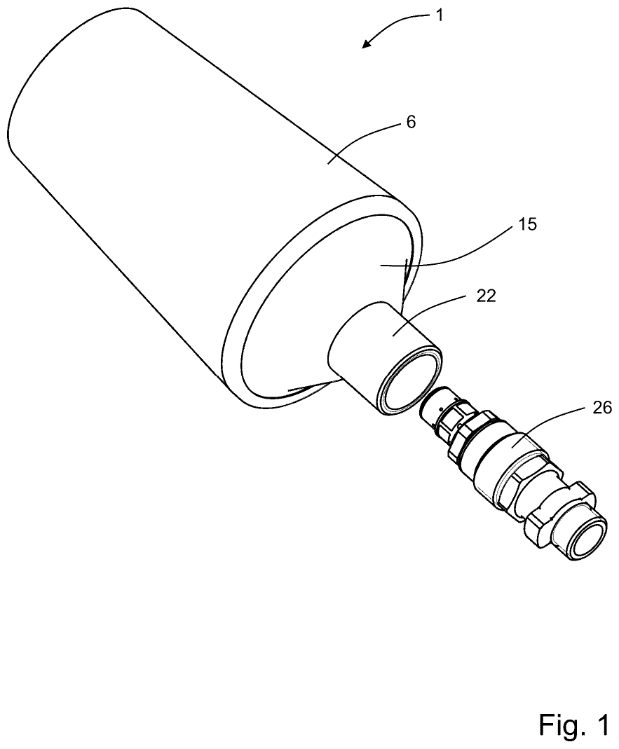

FIG. 1 a perspective view from below of an embodiment of a gas purging plug according to the invention;

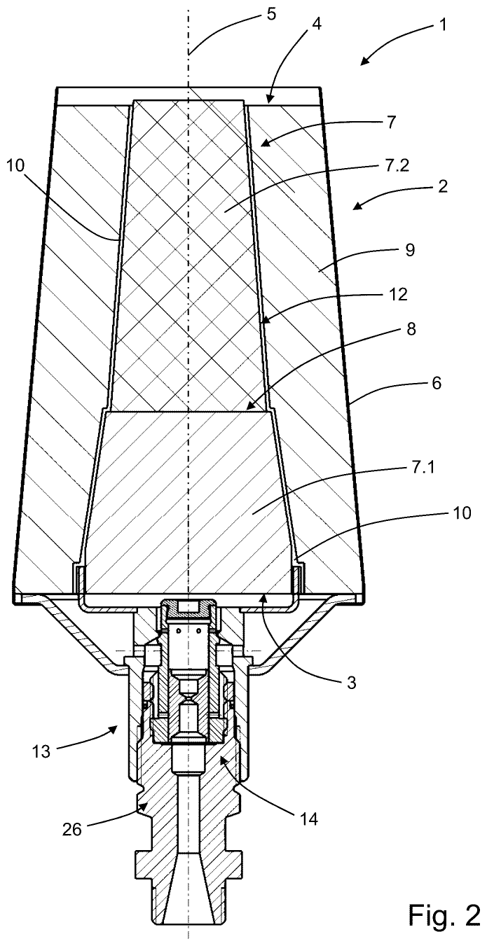

FIG. 2 a sectional view of the gas purging plug according to FIG. 1;

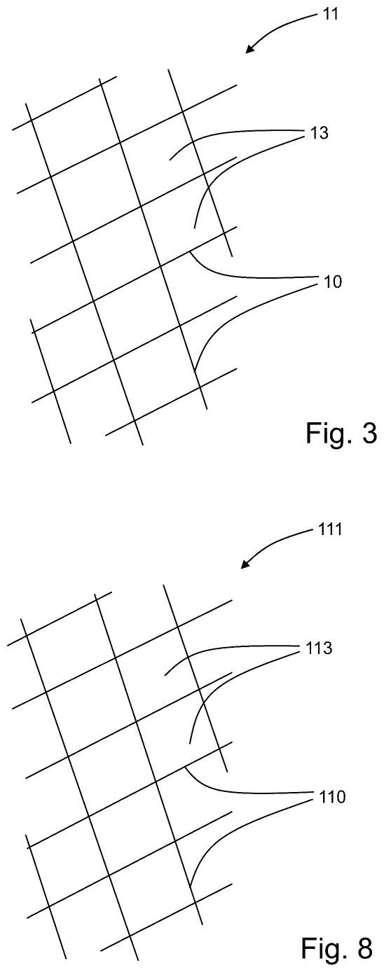

FIG. 3 a detailed view of gas channels in the gas purging plug according to FIG. 1;

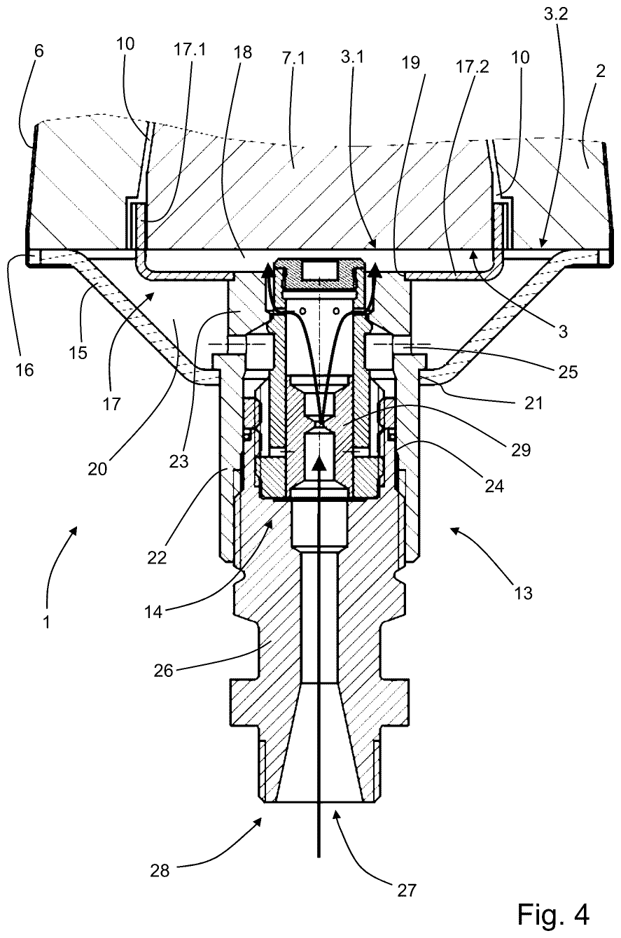

FIG. 4 a detailed view of the sectional view according to FIG. 2 in the area of the gas supply means of the gas purging plug in a first switching position of the control means;

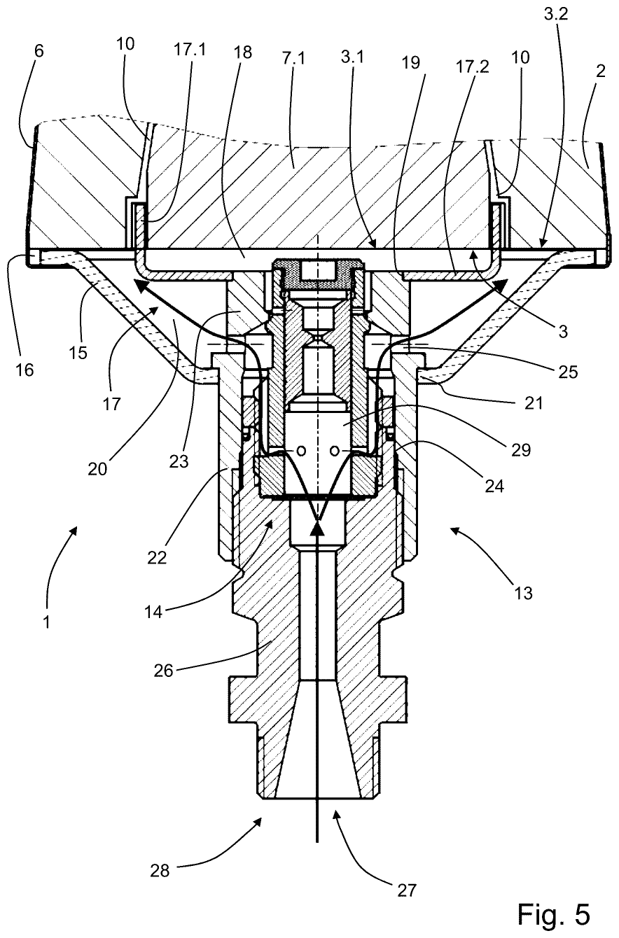

FIG. 5 a detailed view according to FIG. 4 in a second switching position of the control means;

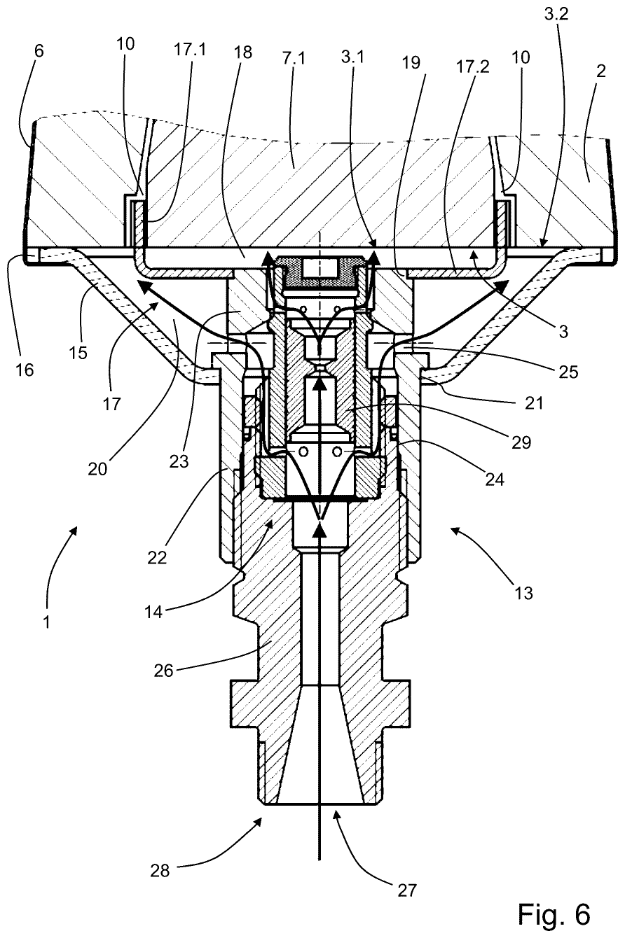

FIG. 6 a detailed view according to FIG. 4 in a third switching position of the control means;

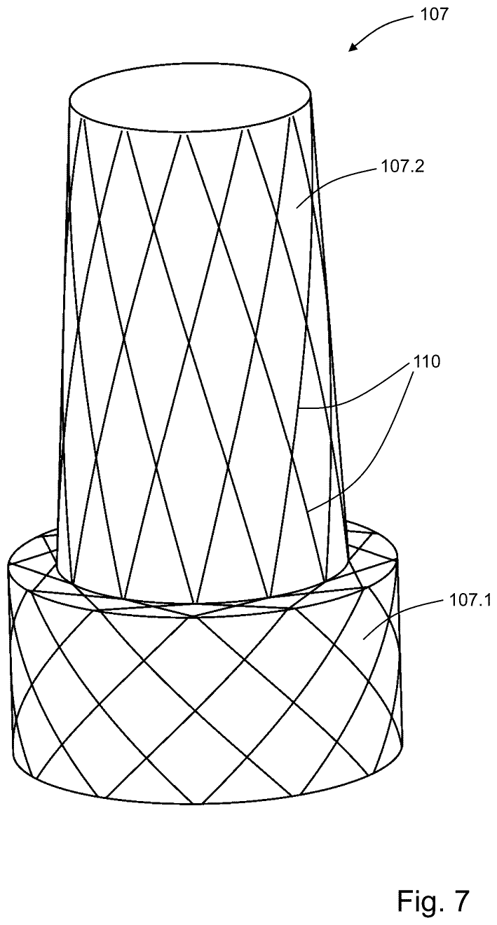

FIG. 7 a perspective view from above of parts from which the of the gas purging plug shall be produced during a manufacturing step of the gas purging plug;

FIG. 8 a portion of the net shown in FIG. 7; and

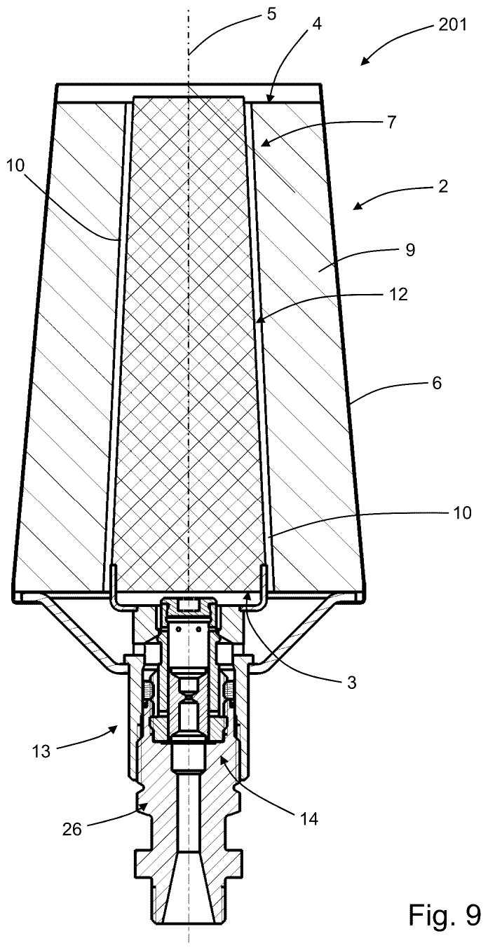

FIG. 9 a sectional view of the gas purging plug of an alternative embodiment of a gas purging plug according to the invention.

### GAS PURGING PLUG ACCORDING TO THE EMBODIMENT OF FIGS. 1 TO 8

In its entirety, the refractory gas purging plug according to the embodiment of FIGS. 1 to 8 is identified in the figures by reference sign 1.

The refractory gas purging plug 1 comprises a body 2 of refractory ceramic material, extending from a first end 3 of the body 2, where gas can be introduced into the body 2, to a second end 4 of the body 2, where gas can be discharged from the body 2, opposite the first end 3 of the body 2.

The body 2 has an overall frustoconical outer contour, which tapers along the longitudinal axis 5 of the body 2 from the first end 3 to the second end 4. At its radial outer contour, the body 2 is completely covered by a metal sleeve 6. As FIG. 1 clearly shows, the gas purging plug 1 thus has an overall frustoconical outer contour which tapers along the longitudinal axis 5 of the body 2 from the first end 3 to the second end 4.

The body 2 comprises a first part 7 made of porous, permeable refractory ceramic material which extends from the first end 3 of the body 2 to the second end 4 of the body 2. The first part 7 is comprised of two segments, a first segment 7.1 and a second segment 7.2. The first segment 7.1 extends from the first end 3 in the direction of the second end 4 to an upper end 8; the second segment 7.2 immediately adjoins the first segment 7.1 and extends to the second end 4. The upper end 8 acts as a first contact surface to contact the second segment 7.2. In the embodiment shown, the first segment 7.1 has the shape of a frustoconical, while the second segment 7.2 has the shape of a cuboid with a rectangular cross-section. By this, the first segment 7.1 also has the function of a wear indicator. In the area of the first segment 7.1, the first end 3 of the body 2 is defined by the gas inlet-side area 3.1 of the first segment 7.1. The first segment 7.1 and the second segment 7.2 are each made of sintered porous, permeable refractory ceramic material based on alumina and magnesia spinel. The first segment 7.1 has a first permeability of 200 nPerm and the second segment 7.2 has a second permeability of 200 nPerm as well.

The first segment 7.1 is covered by a metal cap 17 on its side facing the first end 3. The metal cap 17 has a substantially pot-like shape with side walls 17.1 and a bottom 17.2. The side walls 17.1 surround the lower, radial edge of the first segment 7.1. The bottom 17.2 extends at a distance from the gas inlet side region 3.1 of the first segment 7.1, so that a first gas distribution chamber 18 is formed between the metal cap 17 and the first segment 7.1. The space defined by the first gas distribution chamber 18 is thus defined by the metal cap 17 and the first portion 7, namely the section 7.1 of the first part 7. The bottom 17.2 has a central through opening 19.

The body 2 further comprises a second part 9 made of refractory ceramic material which extends from the first end 3 of the body 2 to the second end 4 of the body 2 and which surrounds the first part 7 entirely and symmetrically. The second part 9 has a frustoconical outer contour which, as described above, is covered on the radial outer surface by the metal sleeve 6. In the region of the second part 9, the first end 3 of the body 2 is defined by the gas inlet side region 3.2 of the second part 9. The refractory material of the second part 9 comprises a refractory ceramic material in the form of cured refractory ceramic material based on alumina and magnesia spinel and has practically no gas permeability with a permeability of <0.05 nPerm. The second part 9 comprises gas channels 10 which are in the form of nets 11 and extending through the second part 9 from the first end 3 of the body 2 to the second end 4 of the body 2. In this respect, the first part 7 provides a surface 12, and wherein the nets 11 partially extend directly on the surface 12 of the first part 7.

As shown in FIG. 3, each of the nets 11 formed by the gas channels 10 are symmetrical nets 11, wherein the gas channels 10 within these nets 11 extend linearly. The meshes 13 surrounded by the gas channels 10 have a mesh size of 4.0 mm. The gas channels 10 have a constant, circular cross-sectional area with a diameter of 0.50 mm.

The second part 9 is covered by a metallic hood 15 on its side facing the first end 3. The hood 15 is welded at the edge along a weld seam 16 to the lower edge of the metal sleeve 6. Leaving free a second gas distribution chamber 20, the hood 15 covers the gas inlet-side 3.1 of the second part 9 of the body 2 and the metal cap 17. The space defined by the second gas distribution chamber 20 is thus defined by the metal cap 17, the hood 15 and the second part 9. The hood 15 has a central through opening 21.

Accordingly, the first gas distribution chamber 18 and the second gas distribution chamber 20 are separated from each other by a wall, namely, the metal cap 17.

The central through-opening 21 of the cap 15 and the central through-opening 19 of the base 17.2 of the metal cap 17 are aligned with each other, with the longitudinal axis 5 of the body 2 passing centrally through the through-opening 21 and the central through-opening 19.

The gas purging plug 1 further comprises gas supply means 13 by which gas can be conducted to the first part 7 and to the second part 9. The gas supply means 13 comprise control means 14 by which the conduction of the gas to the first part 7 and to the second part 9 via the gas supply means 13 is controllable.

The gas supply means 13 are arranged in the region of the first end 3 of the body 2 and are shown in detail in FIGS. 4-6.

The gas supply means 13 are substantially tubular in shape and have a tubular portion 22 which passes through the central through opening 21 of the hood 15 and the central through opening 19 of the bottom 17.2 of the metal cap 17 and opens into the first gas distribution chamber 18.

In the region of the second gas distribution chamber 20 between the bottom 17.2 and the hood 15, the tubular section 22 has a radially outwardly projecting collar 23 by means of which the tubular section 22 bears sealingly against the base 17.2 and the hood 15 and at the same time is positively secured between the metal cap 17 and the hood 15. The tubular section 22 includes an internal bore 24 extending axially through the tubular section 22. Bores 25 are formed in the collar 23 to fluidically connect the bore 24 to the second gas distribution chamber 20.

A tubular body 26 of the gas supply means 13 is arranged in the tubular section 22, in which the control means 14 are arranged. The tubular body 26 has an inner, axial bore 27 through which gas can be conducted from an inlet side 28 of the tubular body 26, through the bore 27 into the first gas distribution chamber 18 and into the second gas distribution chamber 20. From the first gas distribution chamber 18, gas can be directly directed into the first segment 7.1 of the first part 7. Furthermore, gas can be conducted from the second gas distribution chamber 20 directly into the gas channels 10 formed in the second part 9.

The tubular body 26 is configured to be inserted into the tubular section 22 in axial direction. In FIG. 1, the tubular body 26 is shown removed from the tubular section 22.

Through the control means 14 formed in the tubular body 26, the conduction of gas via the gas supply means 13 to the first part 7 and to the second part 9 is controllable. Thereby, the control means 14 are formed in the manner of a directional control valve. The control means 14 have an actuator 29 in the form of a piston, which is movable into different positions by the gas, i.e., pneumatically, flowing into and through the tubular body 26 from the inlet side 28 according to the mass flow of the gas.

Specifically, the actuator 29 is movable to three positions depending on the mass flow of the gas: if gas flows through the tubular body 26 at a mass flow rate within a first range, the actuator 29 assumes a first position, shown in FIG. 4, in which the actuator 29 clears only one gas path through the tubular body 26 into the first gas distribution chamber 18 and blocks the gas path into the second gas distribution chamber 20. When gas flows through the tubular body 26 at a mass flow rate within a second range that is higher than the first range, the actuator 29 assumes a second position, shown in FIG. 5, in which the actuator 29 clears only one gas path through the tubular body 26 and the bores 25 into the second gas distribution chamber 20 and blocks the gas path into the first gas distribution chamber 18. Further, when gas flows through the tubular body 26 at a mass flow rate within a third range that is higher than the first range and lower than the second range, the actuator 29 assumes a third position shown in FIG. 6 in which the actuator 29 clears both a gas path through the tubular body 26 into the first gas distribution chamber 18 and a gas path through the tubular body 26 and the bores 25 into the second gas distribution chamber 20. In FIGS. 4 to 6, the gas paths are indicated by arrows.

Accordingly, gas can be conducted by the gas supply means 13 to the first part 7 via the first gas distribution chamber 18 and to the second part 9 via the second gas distribution chamber 20. At the same time, gas cannot be introduced into the second part 9 via the first gas distribution chamber 18 and not into the first part 7 via the second gas distribution chamber 20.

Further, it can be achieved that at lower mass flow rates of the gas, the gas is conducted to the porous permeable refractory ceramics material of the first part 7, while at higher mass flow rates of the gas, the gas is conducted to the gas channels 10 of the second part 9, while a conduction of gas simultaneously through the first part 7 and the second part 9 can be achieved at medium flow rates of the gas.

At the inlet end 28, the gas supply means 13 have a gas connection to which a gas line (not illustrated) can be connected. The gas line, in turn, can be connected to a gas source (not illustrated). Gas can accordingly be conducted from the gas source via the gas line into the gas supply means 13, and the gas subsequently being conducted via the gas supply means 13 to the first part 7 and to the second part 9 of the body 2.

Of course, the gas channels 10 forming at least one net 11 can also be provided without abovementioned gas supply means 13.

For the production of the body 2 of refractory ceramic material, first, from a first refractory material in the form of alumina spinel low cement castable, two components 107.1, 107.2 are provided as sintered bodies. The two components 107.1, 107.2 have then been assembled together as shown in FIG. 7 to form a first section 107. This first section 107 has the shape of the first part 7 and will form the first part 7 of the refractory gas purging plug 1. The first section 107 provides an outer, radial surface.

Further, plastic nets made of soft polyethylene, and having the dimensions of the nets 11 of the gas channels 10, are provided. Accordingly, as illustrated in FIG. 8, showing a part of such nets 111, each of the nets 111 formed by plastic fibers 110 is a symmetrical net 111, wherein the fibers 110 extend linearly. The meshes 113 surrounded by the fibers 110 have a mesh size of about 4.0 mm. The fibers 110 have a constant, circular cross-sectional area with a diameter of 0.5 mm. As these nets 111 are made of plastic, they are combustible and elastic.

Several of these elastic nets 111 are drawn onto the first section 107 so that some of the nets 111 partially extend directly on the surface of the first section 107.

Further, the first section 107 with the nets 111 arranged thereon is placed into a mold (not shown) and a refractory ceramic mass (not shown) based on alumina spinel low cement castable is poured in the space between the first section 107 and the mold. Thereby, the nets 111 are embedded into the second refractory material. This part, formed by the refractory ceramic mass, forms a second section, having has the shape of the second part 9 and, after burning, will form the second part 9 of the refractory gas purging plug 1.

The first section 107 and the second section, in combination, form an element which, after burning the same, will form the body 2 of the gas purging plug 1.

In a further step, the element, made of the first section 107 and the second section, are heated in a furnace at temperatures of about 500° C., whereby the second refractory material is cured. After heating, the body 5 is produced, wherein the first section 107 forms the first part 7 and the second section forms the second part 9. Further, during heating, the plastic nets 111 are burned out and the gas channels 110 take the place of the burned-out nets 111.

Finally, to produce the gas purging plug 1, the metal sleeve 6 is arranged around the body 5 and the gas supply means 13 are arranged at the gas inlet side of the body 5, as set forth above.

The refractory gas purging plug 1 is used to be arranged in the bottom region of a ladle in a continuous casting plant for treating molten steel.

### Gas Purging Plug According to the Embodiment of FIG. 9

The gas purging plug 201 in the embodiment according to FIG. 9 is largely identical to the gas purging plug 1 according to FIGS. 1 to 8. Insofar as the elements of the gas purging plug 201 according to FIG. 9 are identical to the elements of the gas purging plug 1 according to FIGS. 1 to 8, they are provided with the same reference signs.

One essential difference of the gas purging plug 201, in relation to the gas purging plug 1 according to FIGS. 1-8, is that the first part 7 is one-piece and, hence, not comprised of a first segment 7.1 and a second segment 7.2. Rather, the first part 7 is one-piece having uniform chemical and physical properties, namely, the physical chemical and physical properties according to the section 7.2 according to FIGS. 1-8.

1. Refractory gas purging plug (1), comprising the following features:
1.1 a body (2) of refractory ceramic material;
1.2 the body (2) extends from a first end (3) of the body (2), where gas can be introduced into the body (2), to a second end (4) of the body (2), where gas can be discharged from the body (2), opposite the first end (3) of the body (2);
1.3 the body (2) comprises a first part (7) made of porous, permeable refractory ceramic material which extends from the first end (3) of the body (2) to the second end (4) of the body (2);
1.4 the body (2) comprises a second part (9) made of refractory ceramic material which extends from the first end (3) of the body (2) to the second end (4) of the body (2), the second part (9) comprising gas channels (10) with a defined geometry extending through the second part (9) from the first end (3) of the body (2) to the second end (3) of the body (2);
1.5 gas supply means (13) by which gas can be conducted to the first part (7) and to the second part (9); wherein
1.6 the gas supply means (13) comprise control means (14) by which the conduction of the gas to the first part (7) and to the second part (9) by the gas supply means (13) is controllable.

2. Refractory gas purging plug (1) according to claim 1, wherein the conduction of the gas to the first part (7) and to the second part (9) by the gas supply means (13) is controllable by the control means (14) dependent on the flow behavior of the gas.

3. Refractory gas purging plug (1) according to claim 2, wherein the flow behavior of the gas is the mass flow rate of the gas.

4. Refractory gas purging plug (1) according to claim 2, wherein the conduction of the gas to the first part (7) and to the second part (9) by the gas supply means (13) is controllable by the control means (14) dependent on the flow behavior of the gas in such a way that, dependent on the flow behavior of the gas, the gas can be conducted either to the first part (7) but not to the second part (9) or to the second part (9) but not to the first part (7).

5. Refractory gas purging plug (1) according to claim 3, wherein the conduction of the gas to the first part (7) and to the second part (9) by the gas supply means (13) is controllable by the control means (14) dependent on the mass flow rate of the gas in such a way that, in case the mass flow rate lies within a first range, the gas can be conducted to the first part (7) but not to the second part (9), and in case the mass flow rate lies within a second range, the gas can be conducted to the second part (9) but not to the first part (7), wherein the first range is lower than the second range.

6. Refractory gas purging plug (1) according to claim 5, wherein the conduction of the gas to the first part (7) and to the second part (9) by the gas supply means (13) is further controllable by the control means (14) dependent on the mass flow rate of the gas in such a way that, in case the mass flow rate lies within a third range, the gas can be conducted to the first part (7) and to the second part (9), wherein the third range is higher than the first range and lower than the second range.

7. Refractory gas purging plug (1) according to claim 2, wherein the control means (14) comprise an actuator (29) which can assume different positions dependent on the flow behavior of the gas, wherein the conduction of gas to the first part (7) and to the second part (9) is controllable dependent on the positions of the actuator (29).

8. Refractory gas purging plug (1) according to claim 5, wherein the control means (14) comprise an actuator (29) which can assume different positions dependent on the flow behavior of the gas, wherein the conduction of gas to the first part (7) and to the second part (9) is controllable dependent on the positions of the actuator (29), wherein the actuator (29) assumes a first position when the mass flow rate lies within a first range and wherein the actuator (29) assumes a second position when the mass flow rate lies within the second range, and wherein in the first position, the gas cannot be conducted to the second part (9), and in the second position, the gas cannot be conducted to the first part (7).

9. Refractory gas purging plug (1) according to claim 8, wherein the conduction of the gas to the first part (7) and to the second part (9) by the gas supply means (13) is further controllable by the control means (14) dependent on the mass flow rate of the gas in such a way that, in case the mass flow rate lies within a third range, the gas can be conducted to the first part (7) and to the second part (9), wherein the third range is higher than the first range and lower than the second range, wherein the actuator (29) assumes a third position when the mass flow range lies within the third range, and wherein in the third position, the gas can be conducted to the first part (7) and to the second part (9).

10. Refractory gas purging plug (1) according to claim 1, further comprising:
10.1 a first gas distribution chamber (18) disposed at the first end (3) of the body (2);
10.2 a second gas distribution chamber (20) disposed at the first end (3) of the body (2); wherein
10.3 gas can be introduced into the first part (7) via the first gas distribution chamber (18); and
10.4 gas can be introduced into the second part (9) via the second gas distribution chamber (20).

11. Refractory gas purging plug (1) according to claim 10, wherein gas can be conducted to the first part (7) by the gas supply means (13) via the first gas distribution chamber (18) and wherein gas can be conducted to the second part (9) by the gas supply means (13) via the second gas distribution chamber (20).

12. Refractory gas purging plug (1) according to claim 10, wherein the first gas distribution chamber (18) and the second gas distribution chamber (20) are fluidically separable from each other.

13. Refractory gas purging plug (1) according to claim 1, wherein the gas channels (10) extending through the second part (9) form at least one net (11).

14. Refractory gas purging plug (1) according to claim 1, wherein the first part (7) provides a surface (12) and wherein the at least one net (11) at least partially extends directly on the surface (12) of the first part (7).

15. A method for controlling the conduction of gas to a refractory gas purging plug (1), the method comprising the following features:
A. providing a refractory gas purging plug (1) according to at least one of the preceding claims;
B. controlling the conduction of gas to the first part (7) and to the second part (9) by the gas supply means (13).
